(19) United States
(12) Patent Application Publication
(10) Pub. No.: US 2007/0008564 A1
(43) Pub. Date: Jan. 11, 2007

(54) Image element alignment for printed matter and associated methods

(75) Inventors: Michael A. Friedman, San Antonio, TX (US); Abhijit Junnare, San Antonio, TX (US); Fanyin Wang, San Antonio, TX (US); Michael J. Young, San Antonio, TX (US)

Correspondence Address: JACQUELINE E. HARTT, PH.D;ALLEN, DYER, DOPPELT, MILBRATH & GILCHRIST, P.A., P.O. BOX 3791, ORLANDO, FL, 32802-3791, US

(73) Assignee: Harcourt Assessment, Inc., San Antonio, TX (US)

(21) Appl. No.: 11/348,159

(22) Filed: Feb. 6, 2006

Related U.S. Application Data
(60) Provisional application No. 60/696,751, filed on Jul. 6, 2005.

(51) Int. Cl. G06K 15/02

(52) U.S. Cl. 358/1.11; 358/1.13

(57) ABSTRACT

A system and method are provided for dynamically, automatically aligning an element within textual matter, wherein the element has a vertical extent differing from a vertical extent of surrounding text. The method comprises the step of, based upon a difference between a font size of the text font size and a vertical extent of the element, calculating a vertical offset for placing the element relative to the textual matter. The calculated vertical offset is stored for subsequently achieving a dynamic adjustment in presentation of textual matter with the element placed therein, irrespective of desired output format.

### CROSS-REFERENCE TO RELATED APPLICATION

This application claims priority to provisional patent application 60/696,751, filed Jul. 6, 2005, entitled “Image Element Alignment for Printed Matter and Associated Methods.”

### BACKGROUND OF THE INVENTION

1. Field of the Invention

The present invention relates to systems and methods for creating textual matter, and, more particularly, to such systems and methods for creating textual matter having elements such as images embedded therein of varying vertical heights.

2. Description of Related Art

Textual matter such as printed matter and screen-display matter can contain elements such as images that are sized differently from surrounding text. Such elements may, for example, include mathematical equation elements.

In the traditional process for aligning elements in text, content may exist in, for example, a word processing file such as, but not intended to be limited to, MS Word, with an equation object embedded therein. This text file is then exported to a page layout program, such as Quark XPress, and the math elements are converted to images using a “plug-in,” which may, for example, comprise a package “Math Type.” Math elements are then placed in their intended space, and manually adjusted to a desired location for each element.

Should edits be required in the content, additional manual adjustment is required, both for textual matter and equation elements. Further, material created by plug-ins is not easily exportable, and typically will require additional manual manipulation.

Therefore, it would be advantageous to provide a system and method for creating a unitary image that can be edited and saved in a unitary file, and is adapted for being output in a plurality of formats for a plurality of media.

### SUMMARY OF THE INVENTION

The present invention is directed to a system and method for dynamically, automatically aligning an element within textual matter, wherein the element has a vertical extent differing from a vertical extent of surrounding text. The element may comprise, for example, an image, although this is not intended as a limitation. The method comprises the step of calculating, based upon a difference between a font size of the text and the element's vertical extent, a vertical offset for placing the element relative to the textual matter is calculated. The calculated vertical offset is used for achieving a dynamic adjustment in presentation of textual matter with the element placed therein, irrespective of desired output format. For example, the calculations can be used for deployment to a print medium, although this is not intended as a limitation. As a specific example, mathematical equation editor objects can be vertically aligned with text surrounding it in dynamically created pdf files of a standardized document.

The invention has particular value in its inherent flexibility, since the process can be easily adjusted commensurate with any business rules that impact the textual format.

The features that characterize the invention, both as to organization and method of operation, together with further objects and advantages thereof, will be better understood from the following description used in conjunction with the accompanying drawing. It is to be expressly understood that the drawing is for the purpose of illustration and description and is not intended as a definition of the limits of the invention. These and other objects attained, and advantages offered, by the present invention will become more fully apparent as the description that now follows is read in conjunction with the accompanying drawing.

### BRIEF DESCRIPTION OF THE DRAWINGS

FIGS. 1A-1C are exemplary portions of text having math elements embedded therein, including a fraction attached to a whole number (FIG. 1A), a standalone fraction (FIG. 1B), and a non-fraction image (FIG. 1C).

FIG. 2 is a flowchart for an exemplary embodiment of the method of the present invention for creating textual matter having vertically dissimilar elements therein.

FIG. 3 illustrates an exemplary calculation for embedding images having a height greater than surrounding textual matter.

FIG. 4 illustrates an exemplary calculation for embedding images having a height less than surrounding textual matter.

### DETAILED DESCRIPTION OF THE PREFERRED EMBODIMENTS

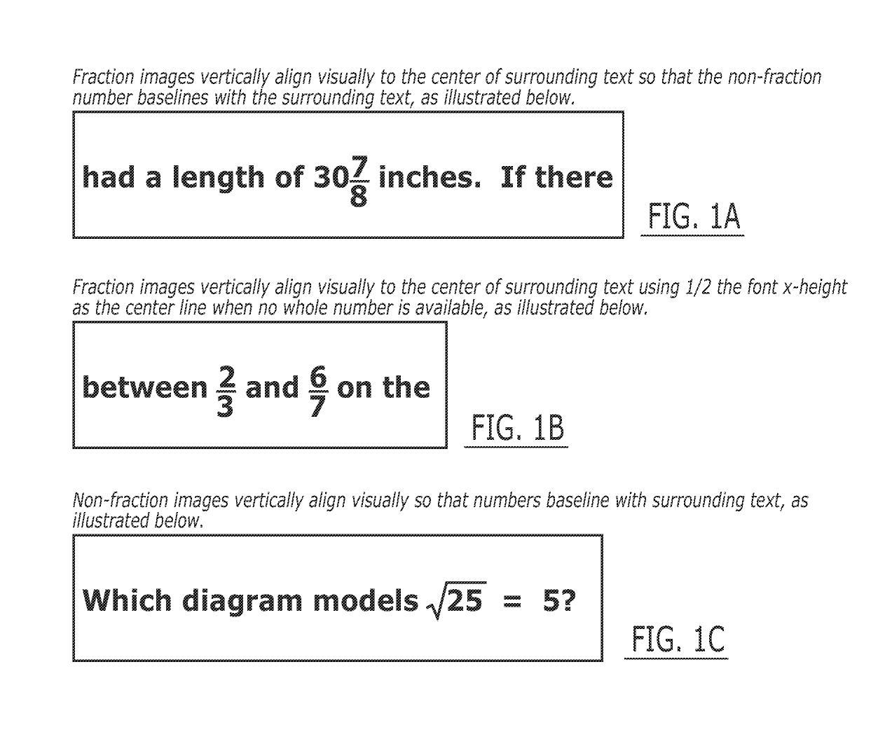

A description of the preferred embodiments of the present invention will now be presented with reference to FIGS. 1A-4.

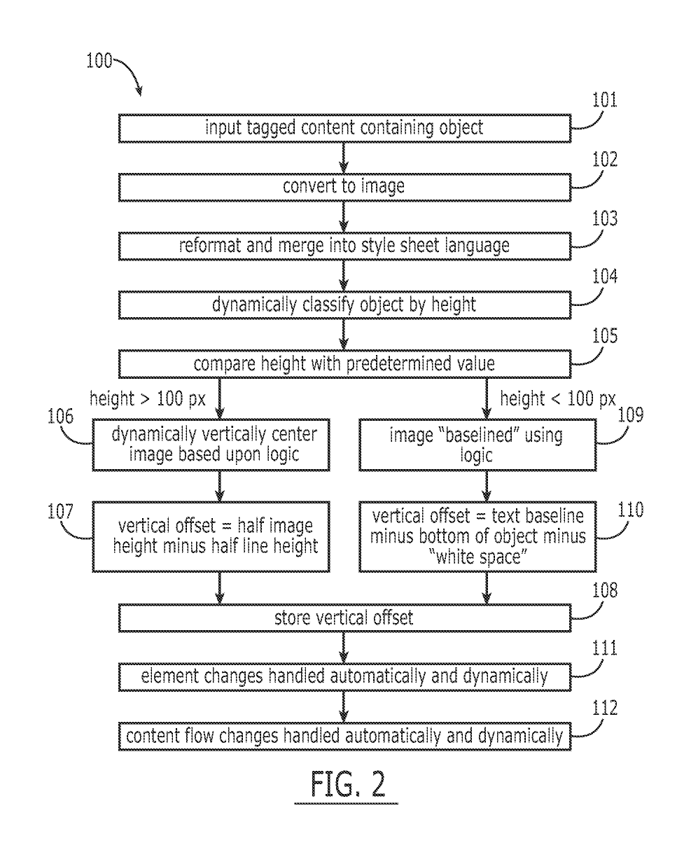

An exemplary method 100 for creating textual matter having objects of varying vertical sizes, as shown in FIGS. 1A-1C, is illustrated in flowchart form in FIG. 2. The method comprises the step of inputting tagged content containing an object for, for example, a math object (block 101), which can include an equation, a fraction, or an answer box, although these are not intended to be limiting. The object is “manually” converted to an image using, for example, a plug-in such as, but not intended to be limited to, “Math Type” (block 102). The tagged text is moved into a textual structure language format, such as XML, and merges with a style sheet language, such as XSLT (extensible style sheet language; block 103).

The math elements are dynamically classified by a predetermined style sheet based upon height (block 104), which is provided as a number in some predetermined scale. Here, for example, all elements are compared with 100 “image points” px (block 105). If the element height is greater than 100 px, the image is dynamically vertically centered using an algebraic logic (block 106). Given a constant line height (for example, 14 pt), a vertical offset is calculated as being equal to the half the image height minus half the line height (block 107). This vertical offset is then stored for subsequently achieving a dynamic adjustment in presentation of textual matter with the element placed therein, irrespective of desired output format (block 108).

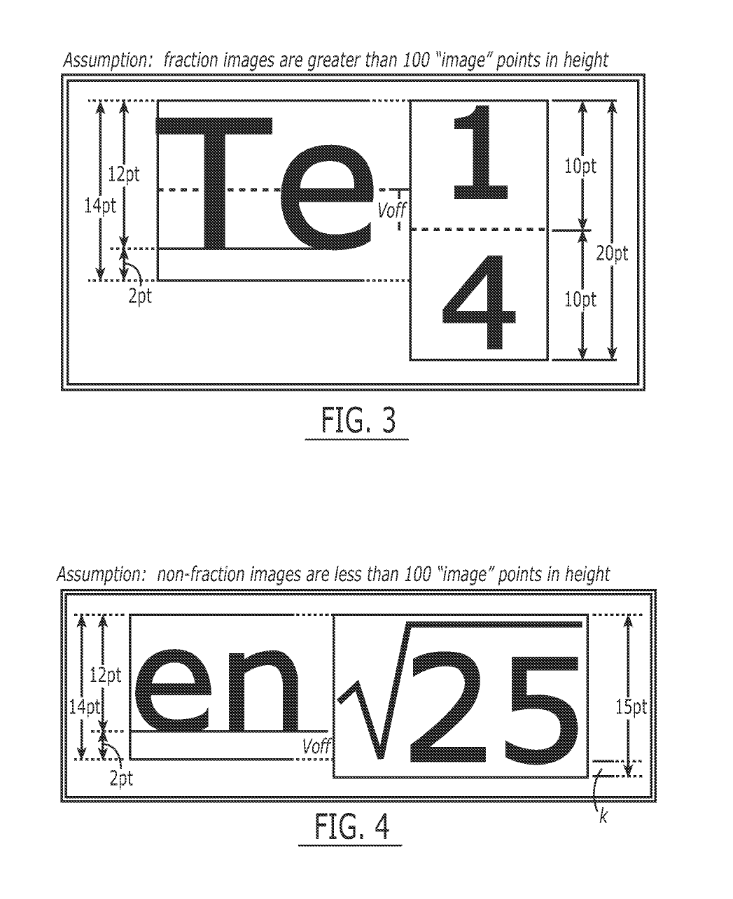

In FIG. 3 is given an example of a fraction that is taller than the surrounding text. The line height is 14 pt, and the image height is 20 pt. A vertical offset is then calculated to be (20 pt/2)−(14 pt/2)=3 pt, that is, a vertical offset of −3 pt to bring the fraction into the centerline of the text.

If the element height is less than 100 px (block 105), the image is dynamically “baselined” using an algebraic logic (block 109). The “baseline” can be described as an imaginary line on which a line of text “rests.” Given the constant line height, the vertical offset is calculated as being equal to the difference between the baseline of the text and the bottom of the object, minus a variable “white space” that is visually estimated, k (block 110). This vertical offset is then stored for subsequently achieving a dynamic adjustment in presentation of textual matter with the element placed therein, irrespective of desired output format (block 108).

In FIG. 4 is given an exemplary calculation for a square root, which is shown to have a height of 15 pt. For a font size of 12 pt, the vertical offset is calculated to be 15 pt−12 pt−k, which is taken to be 1 pt in this case. The vertical offset is then 2 pt, and the element would be adjusted −2 pt upward to visually appear in line with the bottom of the surrounding text.

Once the vertical offset is calculated, any changes to these elements is handled automatically and dynamically, according to the style sheet (block 111). Further, any changes to the flow of content can be handled automatically and dynamically, also according to the style sheet (block 112).

In the foregoing description, certain terms have been used for brevity, clarity, and understanding, but no unnecessary limitations are to be implied therefrom beyond the requirements of the prior art, because such words are used for description purposes herein and are intended to be broadly construed. Moreover, the embodiments of the apparatus illustrated and described herein are by way of example, and the scope of the invention is not limited to the exact details of construction.

What is claimed is:

1. A method for dynamically, automatically aligning an image element within textual matter, the image element having a vertical extent differing from a vertical extent of surrounding text, comprising the steps of:
calculating a difference between a font size of the text and a vertical extent of the image element;
calculating a vertical offset for placing the element relative to the textual matter; and
achieving a dynamic adjustment in presentation of textual matter with the element placed therein using the calculated vertical offset, irrespective of desired output format.

2. The method recited in claim 1, further comprising the steps of:
receiving tagged content containing an object; and
converting the object to an image element.

3. The method recited in claim 2, further comprising the steps, following the object-converting step, of:
reformatting the converted image element; and
merging the converted image element into a style sheet language.

4. The method recited in claim 1, wherein the vertical offset calculating step comprises, if the image vertical extent is greater than a predetermined value, calculating a vertical offset for dynamically vertically centering the image based upon a predetermined rule.

5. The method recited in claim 4, wherein the predetermined rule comprises a calculation comprising: vertical offset equals one-half the image vertical extent minus one-half the font size.

6. The method recited in claim 1, wherein the vertical offset calculating step comprises, if the image vertical extent is less than a predetermined value, calculating a vertical offset for dynamically vertically adjusting a position of a bottom of the image based upon a predetermined rule.

7. The method recited in claim 6, wherein the predetermined rule comprises a calculation comprising: vertical offset equals image height minus font size minus a vertical distance between a position of a bottom of the image and a bottom of a graphical element contained within the image.

8. The method recited in claim 1, further comprising the steps of storing the calculated vertical offset and, if a property of the text changes, retrieving the calculated vertical offset and achieving a second dynamic adjustment in presentation of textual matter with the element placed therein using the calculated vertical offset.

9. A system for outputting a document containing textual matter and an image element comprising:
a processor;
a software package resident on the processor for dynamically, automatically aligning an image element within textual matter, the image element having a vertical extent differing from a vertical extent of surrounding text, comprising code segments for:
calculating a difference between a font size of the text and a vertical extent of the image element;
calculating a vertical offset for placing the element relative to the textual matter; and
achieving a dynamic adjustment in presentation of textual matter with the element placed therein using the calculated vertical offset, irrespective of desired output format.

10. The system recited in claim 9, further comprising an input device in signal communication with the processor, and wherein the software package further comprises code segments for:
receiving tagged content containing an object; and
converting the object to an image element.

11. The system recited in claim 10, wherein the software package further comprises code segments, following the object-converting code segment, for:
reformatting the converted image element; and
merging the converted image element into a style sheet language.

12. The system recited in claim 9, wherein the vertical extent calculating code segment comprises a code segment for, if the image vertical extent is greater than a predetermined value, calculating a vertical offset for dynamically vertically centering the image based upon a predetermined rule.

13. The system recited in claim 12, wherein the predetermined rule comprises a calculation comprising: vertical offset equals one-half the image vertical extent minus one-half the font size.

14. The system recited in claim 9, wherein the vertical extent calculating code segment comprises a code segment for, if the image vertical extent is less than a predetermined value, calculating a vertical offset for dynamically vertically adjusting a position of a bottom of the image based upon a predetermined rule.

15. The system recited in claim 14, wherein the predetermined rule comprises a calculation comprising: vertical offset equals image height minus font size minus a vertical distance between a position of a bottom of the image and a bottom of a graphical element contained within the image.

16. The system recited in claim 9, further comprising a storage medium in signal communication with the processor, and wherein the software package further comprises code segments storing the calculated vertical offset on the storage medium, and, if a property of the text changes, retrieving the calculated vertical offset from the storage medium and achieving a second dynamic adjustment in presentation of textual matter with the element placed therein using the calculated vertical offset.

17. A computer-readable medium having stored thereon a software package for dynamically, automatically aligning an image element within textual matter, the image element having a vertical extent differing from a vertical extent of surrounding text, the software package comprising code segments for:
calculating a difference between a font size of the text and a vertical extent of the image element;
calculating a vertical offset for placing the element relative to the textual matter; and
achieving a dynamic adjustment in presentation of textual matter with the element placed therein using the calculated vertical offset, irrespective of desired output format.

18. The computer-readable medium recited in claim 17, wherein the software package further comprises code segments for:
receiving tagged content containing an object; and
converting the object to an image element.

19. The computer-readable medium recited in claim 18, further comprising code segments, following the object-converting code segment, for:
reformatting the converted image element; and
merging the converted image element into a style sheet language.

20. The computer-readable medium recited in claim 17, wherein the vertical extent calculating code segment comprises a code segment for, if the image vertical extent is greater than a predetermined value, calculating a vertical offset for dynamically vertically centering the image based upon a predetermined rule.

21. The computer-readable medium recited in claim 20, wherein the predetermined rule comprises a calculation comprising: vertical offset equals one-half the image vertical extent minus one-half the font size.

22. The computer-readable medium recited in claim 17, wherein the vertical extent calculating code segment comprises a code segment for, if the image vertical extent is less than a predetermined value, calculating a vertical offset for dynamically vertically adjusting a position of a bottom of the image based upon a predetermined rule.

23. The computer-readable medium recited in claim 122, wherein the predetermined rule comprises a calculation comprising: vertical offset equals image height minus font size minus a vertical distance between a position of a bottom of the image and a bottom of a graphical element contained within the image.

24. The computer-readable medium recited in claim 17, wherein the software package further comprises code segments storing the calculated vertical offset on a storage medium, and, if a property of the text changes, retrieving the calculated vertical offset from the storage medium and achieving a second dynamic adjustment in presentation of textual matter with the element placed therein using the calculated vertical offset.
